(19) United States
(12) Patent Application Publication
(10) Pub. No.: US 2016/0033651 A1
(43) Pub. Date: Feb. 4, 2016

(54) REASSIGNING LICENSE FOR GNSS ACCURACY IMPROVEMENT SERVICE

(71) Applicant: AGCO Corporation, Hesston, KS (US)

(72) Inventors: Gerald R. Johnson, Hesston, KS (US); Jordan Michael Berry, Hesston, KS (US)

(21) Appl. No.: 14/803,985

(22) Filed: Jul. 20, 2015

Related U.S. Application Data
(60) Provisional application No. 62/031,979, filed on Aug. 1, 2014.

(51) Int. Cl. G01S 19/37

(52) U.S. Cl. CPC G01S 19/37

(57) ABSTRACT

In one embodiment, a method comprising maintaining a subscription pool, the subscription pool comprising a first plurality of subscriptions for mutually exclusive access by a second plurality of remotely-located global navigation satellite systems (GNSS) receiver systems, each subscription enabling an improvement in a base accuracy of a respective GNSS receiver among the second plurality of GNSS receiver systems, wherein the first plurality is less than the second plurality; receiving over a network a request for access to the subscription pool; determining if a subscription is available from the subscription pool; enabling access to an available subscription from the subscription pool; and updating the subscription pool responsive to the enabled access.

### CROSS REFERENCE TO RELATED APPLICATION

This application claims the benefit of U.S. Provisional Application No. 62/031,979 filed Aug. 1, 2014, which is hereby incorporated by reference in its entirety.

### TECHNICAL FIELD

The present disclosure is generally related to subscriptions for positioning systems and devices for vehicles.

### BACKGROUND

Global Navigation Satellite Systems (GNSS) provide geographical positioning information from a plurality of orbiting satellites to receivers around the globe including at sea, on the ground, and in the air. The best known of these systems is the U.S. Global Positioning System (GPS), but other systems, such as the Russian GLONASS system, the European Union's Galileo, and China's Compass systems, provide a similar service. They are collectively known as Global Navigation Satellite Systems, and they can provide position accuracies in the range of about ten (10) meters to about fifteen (15) meters. Although the satellites can potentially provide more accurate positions, atmospheric and other effects degrade the quality of the satellite signals.

Unfortunately, GNSS systems are not sufficiently accurate for all applications. An agricultural vehicle operating in a field, for example, may require positioning accuracies of less than one (1) meter. Satellite signals from GNSS systems can be corrected by using one or more reference stations at precisely known locations, which broadcast corrections to GNSS receivers, by way of geostationary satellites for instance (e.g., via Satellite Based Augmentation Systems), in the vicinity of the reference stations. This technique is known as a Differential GNSS (DGNSS) service and it is used to enable precise navigation for ships, aircrafts, and ground vehicles (e.g., vehicles). Positioning systems that leverage the DGNSS service using reference stations and geostationary satellites have sub-meter level precision, enabling tractors to cross agricultural fields in precisely the same track every time, improving crop yields, and in other industries, enabling snow plows, for instance, to operate quickly over roads buried beneath an otherwise trackless snow field. Some systems can achieve decimeter-level precision, where satellites are used to measure ionosphere and clock errors and then pass the resulting corrections to receivers.

Real Time Kinematic (RTK) satellite navigation is another technique used to enhance the precision of position data derived from satellite-based positioning systems using measurements of the phase(s) of a tracked satellite signal's carrier wave(s), rather than the information content of the signal. RTK systems may use a single base station transceiver (or transmitter) as a reference station (e.g., with known geographical coordinates) to provide real-time corrections or correctors to a number of mobile units (e.g., rover receiver units). The base station broadcasts the correction to the observed phase based on its known location, and the mobile units apply the broadcast correction to their own respective phase measurements. The RTK base station may use a real-time communications channel, such as an RF signal, to communicate GNSS information (e.g., correction information or correctors) to the mobile units (e.g., machines).

Currently, many of the services that provide for an improvement in the precision and/or accuracy of the coarse acquisition services of GNSS receiver systems (e.g., via DGNSS, RTK, etc.) are accessible via subscription (e.g., to license holders or subscribers), and each subscription is associated with a specific GNSS receiver system comprising a respective GNSS receiver. There may be several GNSS receiver systems that need to use the service on an as needed basis.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 is a schematic diagram that illustrates an example network topology for an embodiment of a Global Navigation Satellite Systems (GNSS) accuracy improvement system.

FIG. 2 is a flow diagram that illustrates an example start-up configuration process of an embodiment of a GNSS accuracy improvement system, where a farmer enters identifying information and fleet asset information and purchases features.

FIGS. 3-5 are example web-interface diagrams that illustrate various steps in the process depicted in FIG. 2.

FIG. 6 is a flow diagram that illustrates an example process of an embodiment of a GNSS accuracy improvement system by which an operator accesses a subscription pool and makes selections.

FIGS. 7-11 are web-interface diagrams prompted by the operator from a machine that illustrate various steps in the process depicted in FIG. 6.

FIG. 12A is a block diagram that illustrates an embodiment of an example server that manages a subscription pool in an embodiment of a GNSS accuracy improvement system.

FIG. 12B is a flow diagram that illustrates an embodiment of an example GNSS accuracy improvement method from the perspective of a server.

FIG. 13 is a block diagram that illustrates an embodiment of an example GNSS receiver system hosted by a machine and that accesses one or more subscriptions from the server of FIG. 12A.

FIG. 14 is a flow diagram that illustrates another embodiment of an example GNSS accuracy improvement method from a perspective of a server.

FIG. 15 is a flow diagram that illustrates an embodiment of an example GNSS accuracy improvement method from a perspective of a GNSS receiver system.

### DESCRIPTION OF EXAMPLE EMBODIMENTS

### Overview

In one embodiment, a method comprising maintaining a subscription pool, the subscription pool comprising a first plurality of subscriptions for mutually exclusive access by a second plurality of remotely-located global navigation satellite systems (GNSS) receiver systems, each subscription enabling an improvement in a base accuracy of a respective GNSS receiver among the second plurality of GNSS receiver systems, wherein the first plurality is less than the second plurality; receiving over a network a request for access to the subscription pool; determining if a subscription is available from the subscription pool; enabling access to an available subscription from the subscription pool; and updating the subscription pool responsive to the enabled access.

### Detailed Description

Certain embodiments of Global Navigation Satellite Systems (GNSS) accuracy improvement system are disclosed that enable a dynamic re-assignment of sharable licenses or subscriptions (hereinafter, subscriptions and licenses treated the same) to use a GNSS accuracy improvement service. In one embodiment, a computing device, such as a server, maintains a pool of subscriptions for the accuracy improvement service for each client account. The accuracy improvement service may take on the form of one or more complementary signals (i.e., complementary to the satellite signals received by a GNSS receiver) that enable higher precision and accuracy of a GNSS receiver system. For instance, one client account may be for a farmer having a fleet of assets (e.g., agricultural machines), some or all of which are each equipped with a respective GNSS receiver system. Each GNSS receiver system comprises a GNSS receiver having a base or coarse accuracy. In one embodiment, the farmer, through interaction with a start-up configuration process, registers with identifying information (e.g., from home or at a vendor or dealer location or elsewhere) his or her operators of the fleet, the fleet machines, and further purchases one or more subscriptions corresponding to the improved accuracy (e.g., to decimeter or centimeter level accuracy and precision) relative to the coarse accuracy and precision. In one embodiment, the start-up configuration is achieved over a network via a web-interface. The subscriptions may be shared, in mutually exclusive manner, among the registered fleet of vehicles comprising the GNSS receiver systems. In the field, before commencing guided field operations, an operator of the machine (e.g., whether residing in a cab of the machine or controlling the machine remotely) may log on to the website hosting the subscription service, and view whether the subscriptions of a visually represented subscription pool previously purchased in the start-up configuration are in use (not available) or not in use (available). If a subscription is available, the operator selects the subscription and the selected subscription is rendered unavailable until no longer in use (and then returned to the pool with an available status). In some embodiments, the operator of a given machine may serve in an administrator role that enables him or her to activate a subscription for another machine (if available) of the fleet.

In contrast, current accuracy improvement systems used in conjunction with GNSS receiver systems have subscriptions that are tied to a given piece of hardware (e.g., the GNSS receiver). In other words, wherever the GNSS receiver goes, the subscription follows. If the GNSS receiver is built into the host machine, then the subscription is tied to the host machine, leaving the farmer to continue to pay for a subscription that may, along with the machine, sit idle for much of the subscription period (e.g., use for 1 month out of a 6 month subscription period). Some farmers choose to purchase mobile GNSS receivers that can be transferred from machine-to-machine, enabling the subscription to follow. However, the process of switching out a GNSS receiver varies in complexity and hence replacement time, which may be burdensome to the operator. In contrast, certain embodiments of a GNSS accuracy improvement service enables a floating pool of subscriptions, where the subscription is not tied to any single piece of hardware, but rather, shared among a fleet of machines for which the pool of subscriptions applies. For instance, although a farmer may use six (6) machines that host a corresponding GNSS receiver system, he may choose to purchase only three (3) subscriptions for the accuracy improvement system. Three of the subscriptions may be used in conjunction with GNSS receiver systems for three (3) of the machines used during one season or portion of the season, and three (3) machines hosting a respective GNSS receiver system may be used in conjunction with the pool of subscriptions for another season or part of the season. Accordingly, the farmer need not purchase subscriptions for machines that sit idle for most of the subscription period, and he need not worry about the time and effort of moving each GNSS receiver from machine-to-machine or the purchase of another subscription because of a recent purchase of a new machine.

Having summarized certain features of GNSS accuracy improvement system of the present disclosure, reference will now be made in detail to the description of the disclosure as illustrated in the drawings. While the disclosure will be described in connection with these drawings, there is no intent to limit it to the embodiment or embodiments disclosed herein. For instance, in the description that follows, one focus is on an agricultural machine embodied as a combine harvester, though it should be appreciated that some embodiments of GNSS accuracy improvement systems may use other machines, towed and/or self-propelled, in the same or different industries, and hence are contemplated to be within the scope of the disclosure. Further, though emphasis is placed on a GNSS accuracy improvement service embodied as Real Time Kinematic (RTK) correction (e.g., centimeter-level accuracy) using a base station as a reference station, it should be appreciated by one having ordinary skill in the art that other systems or implementations that require subscription-based accuracy improvement services to be tied to the corresponding GNSS receiver to complement the functionality of the GNSS receiver to improve accuracy and/or precision are contemplated to be within the scope of the disclosure. Further, although the description identifies or describes specifics of one or more embodiments, such specifics are not necessarily part of every embodiment, nor are all various stated advantages necessarily associated with a single embodiment or all embodiments. On the contrary, the intent is to cover all alternatives, modifications and equivalents included within the spirit and scope of the disclosure as defined by the appended claims. Further, it should be appreciated in the context of the present disclosure that the claims are not necessarily limited to the particular embodiments set out in the description.

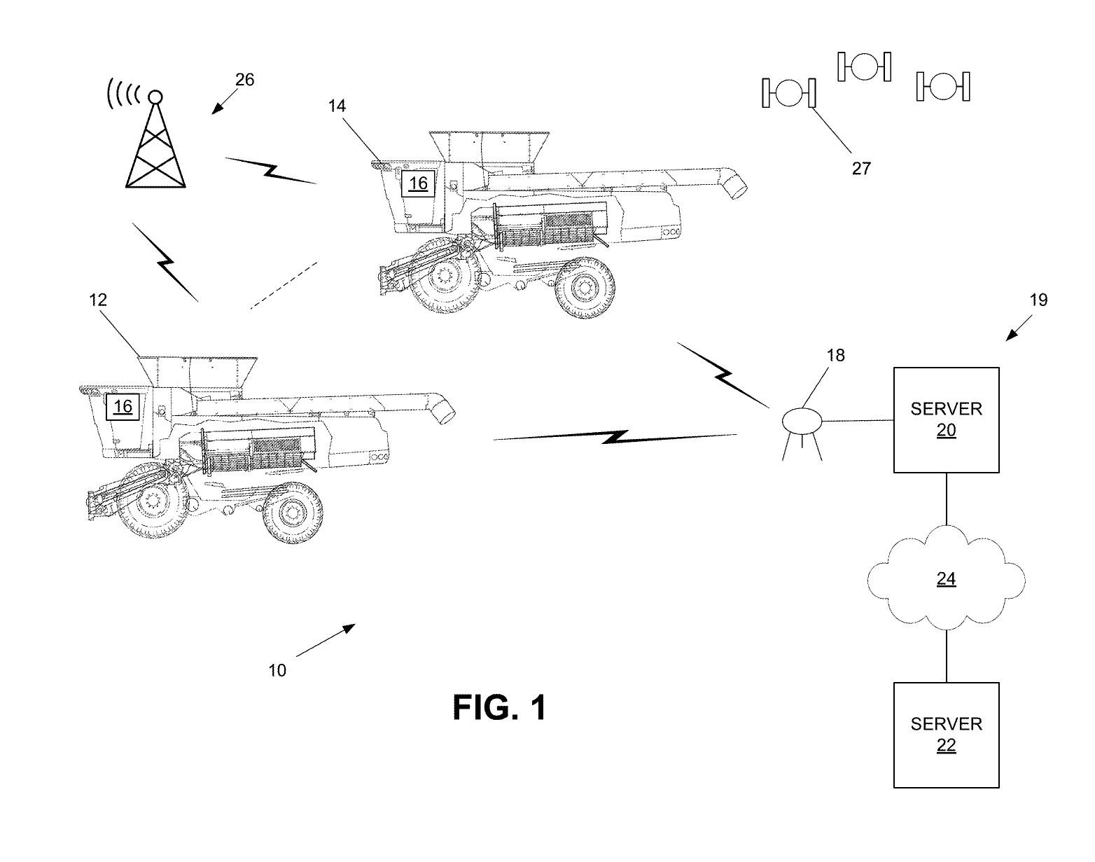

Referring now to FIG. 1, shown is a schematic diagram that illustrates an embodiment of an example Global Navigation Satellite Systems (GNSS) accuracy improvement system 10. It should be appreciated by one having ordinary skill in the art in the context of the present disclosure that the system 10 shown in FIG. 1 is merely illustrative of one embodiment, and that some embodiments may have additional, fewer, or different components to provide accuracy improvement services for a GNSS receiver. The example GNSS accuracy improvement system 10 depicted in FIG. 1 comprises two agricultural machines 12 and 14, each embodied in this example as combine harvesters, and each equipped with a respective GNSS receiver system 16. The GNSS accuracy improvement system 10 further comprises a base station 18 (e.g., reference station) that is fixed in location (e.g., having known geographical coordinates), though some embodiments may utilize a semi-permanent base station that may be moved to other locations of known coordinates). In one embodiment, the GNSS accuracy improvement system 10 further comprises a computer network 19. The computer network 19 depicted in FIG. 1 comprises a server 20 coupled (e.g., hardwired) to the base station 18, and one or more other servers 22 (one shown) coupled to the server 20 over a network 24. The network 24 may comprise a wide area network (e.g., the Internet). In some embodiments, the server 20 may be omitted and the base station 18 may be equipped to (or coupled with a device to) communicate wirelessly (e.g., via a cellular network) to the server 22. The GNSS accuracy improvement system 10 further comprises a cellular network 26 that each of the GNSS receiver systems 16 access to communicate with one or more servers of the computer network 19. The GNSS accuracy improvement system 10 further comprises a satellite network comprising plural satellites 27 that provide GNSS information comprising coarse acquisition codes and carrier information in one or more signals (e.g., for Global Positioning Systems, or GPS, L1 and L2 signals). The GNSS receivers of the GNSS systems 16 receive the satellite signals from the satellites 27, and use the GNSS information to enable a determination of the position of the machines 12 and 14 according to sub-meter accuracy. For improved accuracy (e.g., centimeter-level accuracy in the case of RTK correction), the GNSS receiver systems 16 utilize an accuracy improvement service based on a subscription to that service. For instance, and using RTK correction as an example and assuming an available subscription under activation for each machine 12 and 14, the GNSS information received by the GNSS receivers of the GNSS receiver system 16 is complemented with RTK correction received from the base station 18. As is known, the base station 18 receives the GNSS information from the satellites 27 and also a carrier phase that is tracked to provide real-time correction to the GNSS information based on the carrier phase and known coordinates of the base station 18. The RTK correction is communicated (e.g., broadcast) to the GNSS receiver systems 16 of the machines 12 and 14, which is used along with the GNSS information received from the satellites 27 to provide for a geographical position of each machine 12 and 14 to centimeter-level accuracy. In some embodiments, the RTK correction may be determined based on use of a network of base stations 18 (e.g., plural base stations).

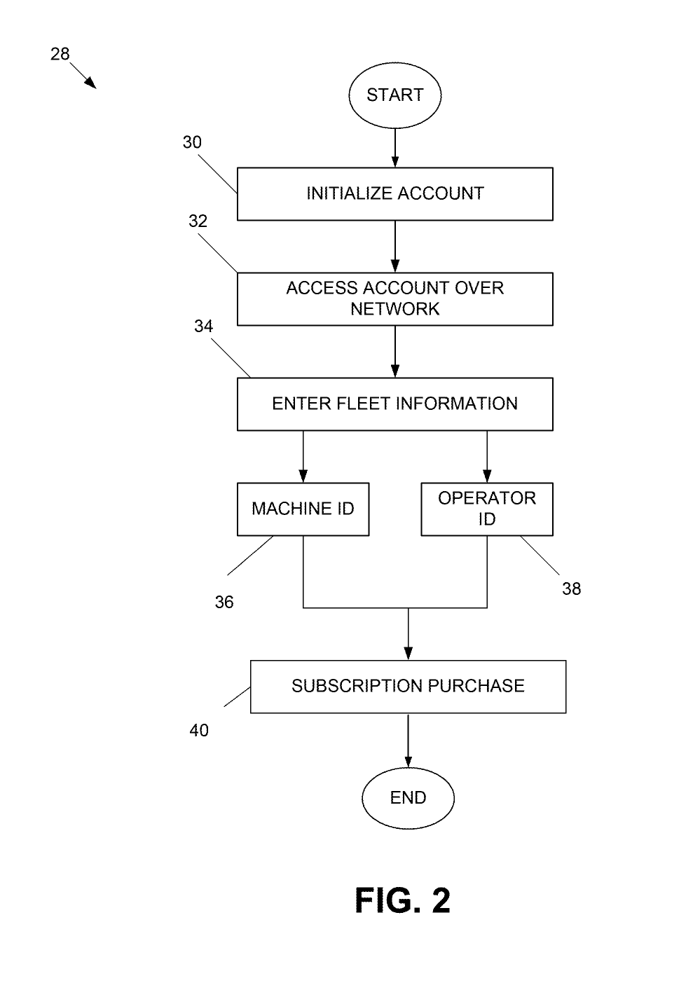

Referring now to FIG. 2, shown is a flow diagram that illustrates an example start-up configuration process 28 for an embodiment of a GNSS accuracy improvement system 10, where a farmer (and/or his or her representative) enters identifying information (e.g., operator information) and fleet information, and purchases accuracy improvement features among possibly other features. In one embodiment, the farmer initializes an account (30) with an accuracy improvement service. The farmer may visit an office of an accuracy improvement service provider, or an equipment dealer, or other representative. In some embodiments, the start-up configuration may be performed from the convenience of the farmer's residence or office (e.g., online). For purposes of this example, it is assumed the farmer has visited an office of an equipment dealer and has purchased either a machine and/or a GNSS receiver. At the visit, the farmer may be provided with an account and a login ID to enable the start-up configuration to proceed on-line with a subscription service. At (32), the farmer (or his or her representative) accesses the account over a network (e.g., over the Internet). At this point, the farmer may enter fleet information (34). For instance, the fleet information may include a machine identification 36 and operator (user) identification 38. That is, the farmer may enter into the system via a web-interface all machines owned or otherwise possessed by the farmer that includes, or is capable of including, a GNSS receiver. The farmer may enter user-configured machine-identification 36 (e.g., Joe's combine, Joe's baler, etc.), and/or model, year, and/or name (among other identifying information) of the manufacturer of each machine from a drop-down list based on stored machine model information or user-entered information. The farmer may also enter the identification of all operators of his or her fleet, as well as password information for each user or operator. Further, the farmer may transact a purchase of one or more subscriptions (40) for the accuracy improvement service.

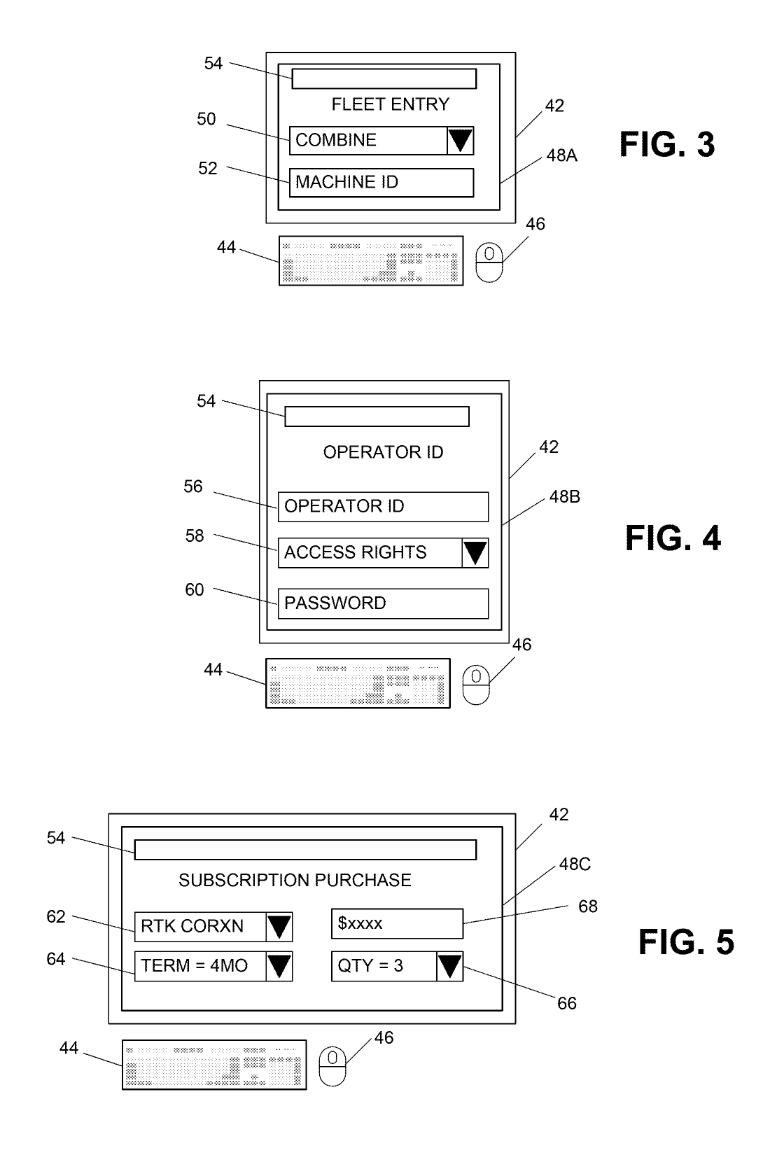

Attention is now directed to FIGS. 3-5, which illustrate some example web-interfaces (e.g., or generally, visual representations) associated with various steps in the start-up configuration process 28 depicted in FIG. 2. It should be appreciated by one having ordinary skill in the art that the web-interfaces are merely illustrative, and in some embodiments, fewer, greater, or different features may be presented, and/or functionality associated with two or more web-interfaces may be combined, and/or some web-interfaces may be omitted. The web-interfaces may be presented on a display screen 42 located proximally to the farmer or farmer's representative (hereinafter, collectively referred to as a user except where noted below). The display screen 42 depicted in FIGS. 3-5 may be coupled to, or integrated with, a work station or laptop or other computing device (not shown) equipped with a web browser to access one or more servers that host the subscriber-based, accuracy improvement services. User selections or generally, interactions, with the web-interfaces presented on the display screen 42 are the depicted as being achieved via communicatively-coupled peripherals, such as a keyboard 44 and mouse 46. In some embodiments, user interactions with the web-interfaces presented on the display screen 42 may be according to other mechanisms, such as verbal instructions (e.g., using voice recognition technology), virtual mechanisms (e.g., detected hand motions), or touch-screen type technology, as should be appreciated by one having ordinary skill in the art. Referring to FIG. 3, with continued reference to FIG. 2, a web-interface 48A is presented to the user to facilitate the entering, by the user, of fleet information (blocks 34 and 36 of FIG. 2). The type of machine may be selected from a drop down menu 50, where a plurality of different types of machines common to the agricultural industry are presented for selection. In this example, the user has selected a combine harvester. Also presented in the web-interface 48A is a machine ID entry window 52, which enables the user to type in identifying information about the machine, such as Joe's combine or to enter other information, such as model number, year, etc. In some embodiments, additional machine ID entry windows may be presented for a more comprehensive identification process. Also shown in the web-interface 48A is a browser bar 54 (or equivalently, tool bar or ribbon), similar to other web browser interfaces, that enables the user to navigate between screens and otherwise facilitate interactions with the web-interfaces in known manner. Successive machines to be entered (registered) can be accomplished in one of a variety of different ways. For instance, upon completion of the information for a given machine and identification of the machine, a window prompt may be presented querying whether additional machines are to be entered. Other mechanisms may be used according to methods well-known in the art, and hence are omitted here for brevity.

Referring to FIG. 4, the web-interface 48B is presented to facilitate the entry of identifying information for operators designated by the user for his or her fleet of machines, as set forth in block 38 of FIG. 2. Like other web-interfaces 48 described herein, the web-interface 48B comprises the browser bar 54, and further includes an operator ID entry window 56, an access rights drop down menu 58, and a password entry window 60. The user may enter the name of each operator in the operator ID entry window 56, and select access rights for the identified operator in the access rights drop down menu 58. For instance, the user may restrict an operator's ability to access a subscription pool, or effect restrictions in the activation of a subscription for other machines (towed or self-propelled). Conversely, the user may grant administrator access rights to enable an operator to activate subscriptions from the pool of subscriptions for all (or portion of) other machines of the fleet in a field. The password entry window 60 enables the user to assign a password to be used in authenticating an operator that attempts to access the subscription pool. As similarly discussed in association with the web-interface 48A, a prompt or other mechanisms may query the user as to whether additional operators are to be registered.

In FIG. 5, the web-interface 48C presented on the display screen 42 enables a user to purchase a desired quantity of subscriptions for the accuracy improvement service (e.g., RTK correction service), as indicated in block 40 of FIG. 2. The web-interface 48C comprises a drop down menu 62 for selection of the service feature for which subscriptions are to be purchased, a drop down menu 64 for the desired term or duration (e.g., four (4) months, six (6) months, etc.) of the service, a drop down menu 66 for the desired quantity of subscriptions, and an accumulate window 68 that automatically sums up the cost of the subscription purchases based on the data entered in the web-interface 48C of FIG. 5. The user may transact the purchase through additional screens, or invoicing may be subsequent to the start-up configuration process, among other mechanisms for payment. It is noted that the user has selected RTK correction in the drop down menu 62, which assumes other subscription services (e.g., other correction or correction-related services, or other GNSS or non-GNSS related services) are available. In some embodiments, only RTK correction is offered, and hence the drop down menu 62 is omitted or RTK correction is a default, single option. If additional subscription features are offered, a prompt or other mechanism may query the user as to whether additional information is to be entered.

It should be appreciated, within the context of the present disclosure, that the example web-interfaces 48 (e.g., 48A, 48B, and 48C) may omit certain entry windows or drop down menus, or substitute drop down menus for entry windows and vice versa. Other mechanisms may be used, such as displayed lists with drag and drop functionality, as would be appreciated by one having ordinary skill in the art.

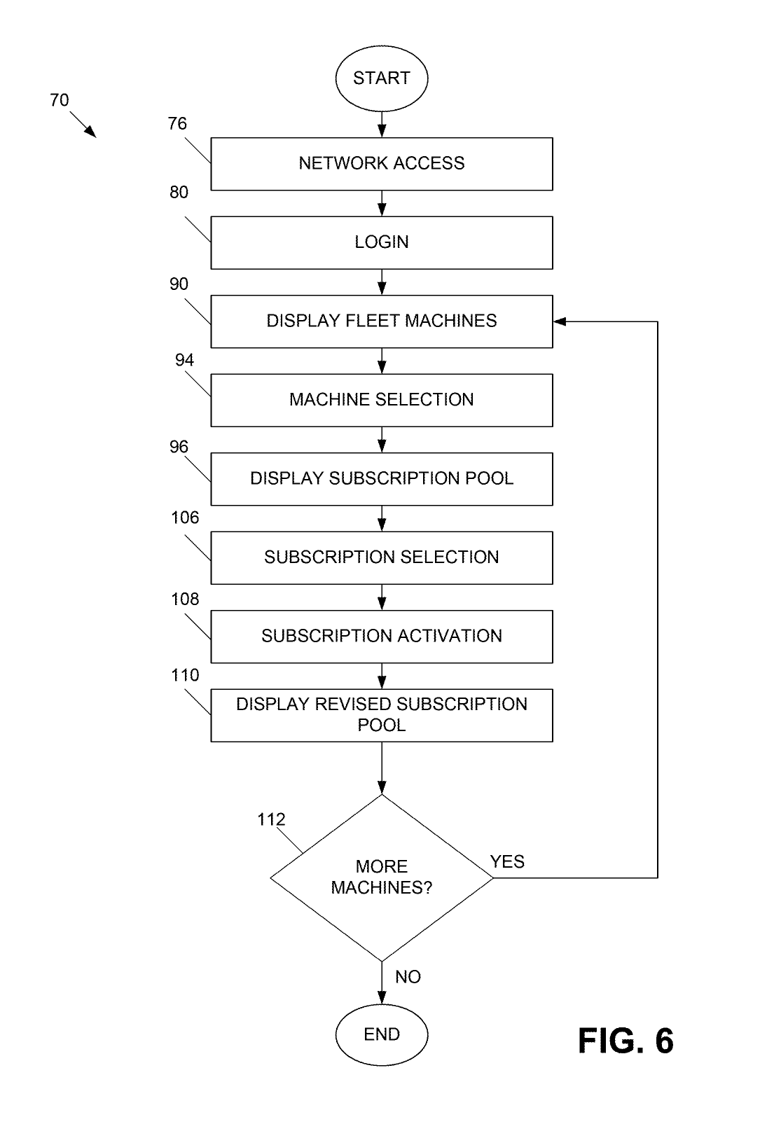

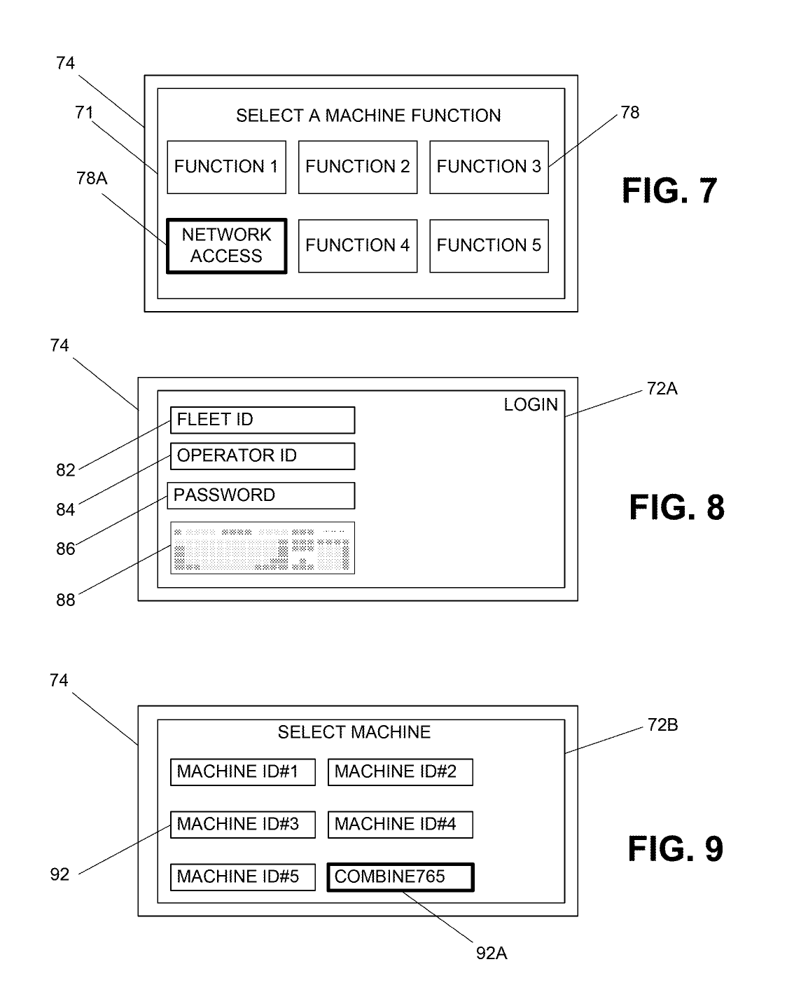

Attention is now directed to FIG. 6, which illustrates an example process 70 for an embodiment of a GNSS accuracy improvement system 10, whereby an operator accesses a subscription pool and makes subscription selections. Concurrently with the description of the process 70, references are made to the various functions in a menu 71 (FIG. 7) and web-interfaces 72 in FIGS. 8-11 that collectively are visual representations that facilitate operator intervention through the process 70. The menu 71 and the web-interface screens 72 may be presented on a display screen 74 residing in the cab of the respective machine 12 and 14 (or remotely for remote control applications), and in the depicted examples, the display screens 74 are embodied as touch-type display screens that present a graphical symbol (e.g., icon) to be selected, or a graphical symbol in the form of a keyboard that enables text entry. It should be appreciated that other mechanisms for text entry and/or symbol selection may be used (including other types of screens 74), and hence are contemplated to be within the scope of the disclosure. Also, for brevity, the browser bar is omitted from these web-interfaces 72 and corresponding discussion. Referring to FIG. 6, the process 70 commences with commencing network access (76). In FIG. 7, the operator is presented with a machine function menu 71 that may be an initial menu presented on the display screen 74 upon machine or electronics system power-up. The menu 71 is shown with plural machine function icons 78 corresponding to different machine functions. In this example, to access the network, the operator selects the network access icon 78A (the selection represented by the bold font outline of the icon 78A compared to the outlines of the other icons 78). Response to the selection, cellular modem functionality in the GNSS receiver system 16 accesses the computer network 19 (FIG. 1) to access the subscription pool for the fleet to which the operator belongs.

Referring to FIG. 6, the operator logs in to a server (80) of the computer network 19. FIG. 8 depicts one example web-interface 72A that is presented on the display screen 74 residing in the cab of the machine 14 (or 16). The web-interface 72A enables the operator to log in by entering login information through plural entry windows 82 (e.g., fleet ID), 84 (e.g., operator ID), and 86 (password). The information is entered into these windows 82-86 via a graphical keyboard 88 presented in the web-interface 72A, though other mechanisms (e.g., using verbal commands or coupled peripherals, etc.) may be used in some embodiments. The server compares the information entered in the web-interface 72A with the information entered during the start-up configuration process 28 (FIG. 2), and authenticates the operator before proceeding with the process 70 (FIG. 6). As should be appreciated by one having ordinary skill in the art, should authentication fail (e.g., mismatch of information, or an absence of appropriate access rights), access to the accuracy improvement service is denied.

Assuming access to the accuracy improvement service is granted, the process 70 presents a list of the fleet machines of that account to which the operator belongs (90). Referring to FIG. 9, the identity of each of the machines entered as part of the start-up configuration process and stored at, or in association with, the server is presented as a list of selectable icons 92 in the web-interface 72B. In this example, there are six (6) icons corresponding to six (6) machines having GNSS receiver systems 16 in the fleet for the present account.

Referring again to FIG. 6, there is a machine selection (94). For instance, and referring to FIG. 9, the icon 92A corresponding to the machine identified as “combine765” is selected, as noted by the boldface outline in the web-interface 72B.

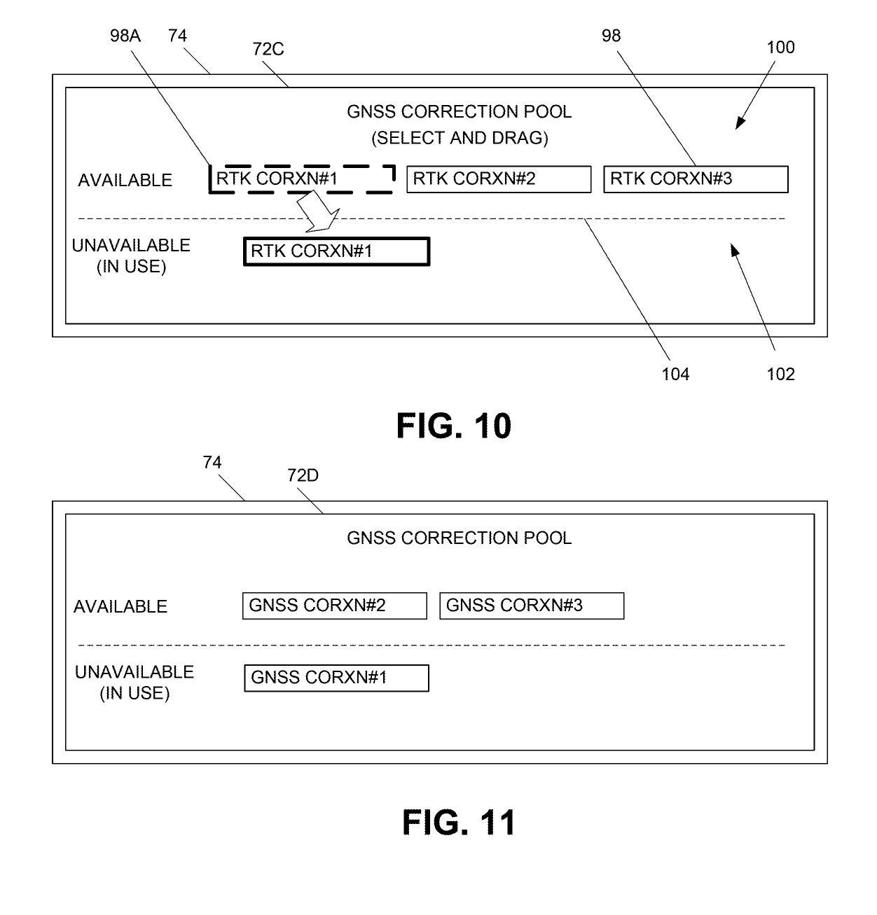

Responsive to the operator selection of the icon 92A and referring to FIGS. 6 and 10, the process 70 provides a web-interface 72C that visually represents a subscription pool (96) based on the farmer's selections in the web-interface 48C of FIG. 5. The web-interface 72C visually represents the subscriptions of the subscription pool as icons 98, and visually distinguishes the subscriptions of the subscription pool that are in use (and hence having a status of unavailable) and subscriptions of the subscription pool that are not in use (available status). For instance, in one embodiment, the web-interface 72C is delineated into plural (e.g., two (2)) regions—an available region 100 and an unavailable region 102 separated by a delineator (e.g., a dashed line) 104. These regions 100 and 102 also serve as underlying logical partitions of the subscription pool for subscriptions that are available and those that are not. The available region 100 shows icons 98 for three (3) subscriptions for RTK correction, corresponding to the selection of three (3) subscriptions made in the web-interface 48C of FIG. 5. In this example, the operator selects (106) the icon 98A from the available subscriptions in region 100 and performs a drag and drop operation on the icon 98A, as represented by the dashed and boldface outline of the icon 98A and the arrow-head overlapping the delineator 104 signifying a real-time transfer of the subscription corresponding to icon 98A to the unavailable region 102. In effect, the subscription has now been activated (108) (e.g., status has changed to in-use), and a web-interface 72D is presented with the revised subscription pool (110) where the selected RTK correction subscription is shown changed in status from available (not in use) to unavailable (in use), as depicted in FIG. 11. The subscription pool has now been altered such that there are two (2) subscriptions available for use (instead of three (3)) in the fleet while the selected subscription is in use and unavailable. Further, with the subscription activated for RTK correction, the GNSS receiver system 16 is now equipped for centimeter-level navigational guidance for that machine. If the operator has administration access rights, a prompt may be displayed querying whether subscription activation is desired for other machines (assuming additional subscriptions are available) as set forth in block 112. If desirous to enable GNSS receiver systems 16 of other machines for RTK correction, the process 70 once again displays the fleet of machines (90, FIG. 6) as set forth in web-interface 72B in FIG. 9, otherwise, the process 70 ends and the operator may be presented with the main menu 71 of FIG. 7 or a screen pertaining to auto guidance or some other screen.

It should be appreciated that the drag and drop operation described above and illustrated in FIG. 10 is merely illustrative of one embodiment, and that some embodiments may enable activation of subscriptions using other well-known techniques, such as through the use of drop down menus, button selection, icon selection without drag and drop, etc. Further, the sequence of web-interfaces 72 are also merely illustrative of on embodiment, and in some embodiments, the functionality corresponding to some web-interfaces 72 may be combined, omitted, or added to the process 70. When the subscription in use is no longer in use (e.g., based on a predetermined time of no RTK use, or as shut-down by an operator), the subscription is automatically returned back to the available status. In some embodiments, a separate web-interface may be deployed to enable the operator to drag the subscription in region 102 back to region 100.

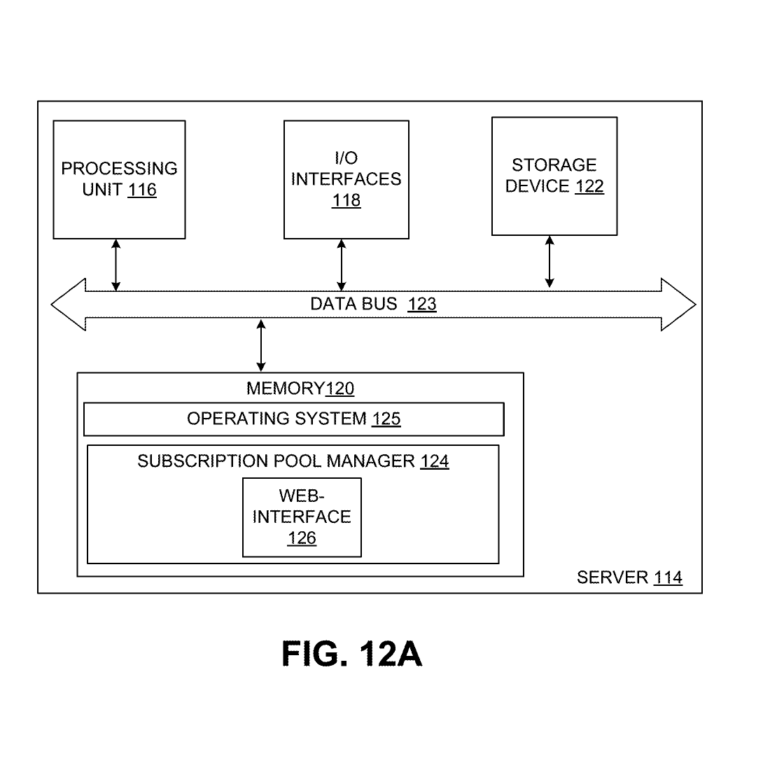

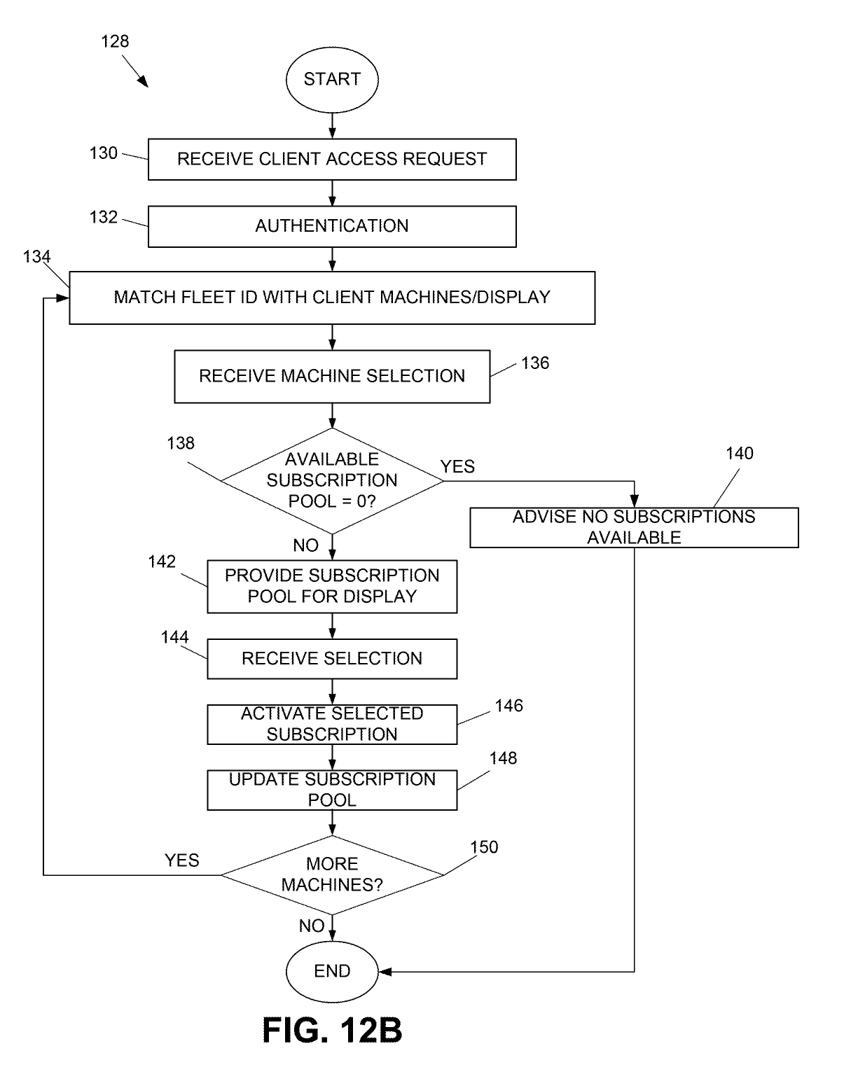

Having described some embodiments of example processes 28 and 70 that enable a user or operator to interact with computing devices located remotely from machine 12 and 14 or hosted by the machines 12 and 14, attention is directed to FIG. 12A, which illustrates an embodiment of an example server 114 that manages a subscription pool. The server 114 may be a computing device embodied as the servers 20 or 22 of FIG. 1. One having ordinary skill in the art should appreciate in the context of the present disclosure that the example server 114 is merely illustrative, and that some embodiments of servers may comprise fewer or additional components, and/or some of the functionality associated with the various components depicted in FIG. 12 may be combined, or further distributed among additional modules, in some embodiments. It should be appreciated that other components well-known in the art have been omitted for brevity. In one embodiment, the server 114 comprises one or more processing units, such as processing unit 116, input/output (I/O) interface(s) 118, memory 120, and a storage device 122, all coupled to one or more data busses, such as data bus 123. The memory 120 and the storage device 122 may include any one or a combination of volatile memory elements (e.g., random-access memory RAM, such as DRAM, and SRAM, etc.) and nonvolatile memory elements (e.g., ROM, hard drive, tape, CDROM, etc.). The memory 120 may store a native operating system, one or more native applications, emulation systems, or emulated applications for any of a variety of operating systems and/or emulated hardware platforms, emulated operating systems, etc. In the embodiment depicted in FIG. 12A, the memory 120 comprises an operating system 125 and subscription pool manager software 124. The subscription pool manager software 124 comprises a web-interface module 126 that enables access by browser software located on a remote computing device, enabling a user or operator at a remote location to interact with the server 114 to register a fleet of machines and the associated operators as well as to purchase and then select for mutually exclusive use the purchased subscriptions pertaining to GNSS accuracy improvement services, such as RTK correction as well as other correction services that improve upon the accuracy of coarse acquisition GNSS receivers. The subscription pool may be formatted in a data structure (e.g., database, linked list, etc.) that is stored in storage device 122 (or memory 120 in some embodiments), associated therein with the farmer and operators and the registered fleet of vehicles through the start-up configuration process 28 and the subscription activation enabled through the process 70 of FIGS. 2 and 6, respectively. The storage device 122 may be embodied as persistent memory (e.g., optical, magnetic, and/or semiconductor memory and associated drives). It should be appreciated that in some embodiments, additional or fewer software modules (e.g., combined functionality) may be employed in the memory 120 or additional memory.

The subscription pool manager software 124 provides functionality through executable code that implements a method 128 in a computing device, such as the server 114 shown in FIG. 12A. The method 128 is shown in the flow diagram of FIG. 12B. In one embodiment, the method 128 comprises receiving a client access request (130), authenticating the login user (132), and matching the fleet identification associated with the user login procedure and displaying the machines (134). The matching may be achieved by comparing the information entered in the web-interface 72A of FIG. 8 during the login process with data stored in the storage device 122 of or associated with the server 114. As explained previously, the method 128 presents, via the web-interface module 126, the identity of the machines (see web-interface 72B of FIG. 9), and receives from the remote computing device a machine selection (136). The method 128 further comprises determining whether there are no available subscriptions (138), such as for the accuracy improvement services. In some embodiments, the query may be whether there are available subscriptions, as should be appreciated by one having ordinary skill in the art. For instance, the subscription pool manager software 124 maintains a count of the number of available subscriptions and the total quantity of subscriptions, and if the quantity of available subscriptions equals zero (0), then there are none available. Accordingly, if the count corresponding to the number of subscriptions that are available equals zero (0), then the answer to whether there are none available is “yes,” and the method 128 alerts the operator located at the remote computing device that none are available (140) and the process 128 ends.

On the other hand, if the answer is “no” (i.e., subscriptions are available), the method 128 presents visual representations of the subscription pool (142) as shown in the web-interface 72C of FIG. 10. Note that in some embodiments, the subscription pool may be displayed regardless of whether there are subscriptions available in some embodiments. The method 128 receives a selection of one of the available subscriptions (144) presented on the web-interface 72C, and activates the selected subscription (146) (e.g., by changing the status from available to unavailable). As shown in FIG. 10, this process of selection and activation can be implemented via the operator performing a drag and drop operation in the web-interface 72C, among other mechanisms for activating a desired feature. The method 128 further comprises updating the subscription pool (148). For instance, the method 128 may decrement a count of available subscriptions (or equivalently, increment a count of unavailable subscriptions, or both). The method 128 may optionally query the operator (e.g., having administrative access rights, or if a towed machine attached to the current machine comprises a GNSS receiver system 16 for which a subscription is required or desired) as to whether there are more machines for which a subscription is desired (150). If the answer to that query is “yes,” the method 128 returns to (134) which includes displaying the fleet of machines, otherwise (“no”) the method 128 ends.

Referring again to FIG. 12A, execution of the software modules 124 and 126 may be implemented by the processing unit 116 under the management and/or control of the operating system 125. The processing unit 116 may be embodied as a custom-made or commercially available processor, a central processing unit (CPU) or an auxiliary processor among several processors, a semiconductor based microprocessor (in the form of a microchip), a macroprocessor, one or more application specific integrated circuits (ASICs), a plurality of suitably configured digital logic gates, and/or other well-known electrical configurations comprising discrete elements both individually and in various combinations to coordinate the overall operation of the server 114.

The I/O interfaces 118 provide one or more interfaces to the networks 19, 26, and the base station 18 (FIG. 1). In other words, the I/O interfaces 118 may comprise any number of interfaces for the input and output of signals (e.g., analog or digital data) for communication over the networks 19, 26 and/or with the base station 18.

When certain embodiments of the server 114 are implemented at least in part as software (including firmware), as depicted in FIG. 12A, it should be noted that the software can be stored on a variety of non-transitory computer-readable medium for use by, or in connection with, a variety of computer-related systems or methods. In the context of this document, a computer-readable medium may comprise an electronic, magnetic, optical, or other physical device or apparatus that may contain or store a computer program (e.g., executable code or instructions) for use by or in connection with a computer-related system or method. The software may be embedded in a variety of computer-readable mediums for use by, or in connection with, an instruction execution system, apparatus, or device, such as a computer-based system, processor-containing system, or other system that can fetch the instructions from the instruction execution system, apparatus, or device and execute the instructions.

When certain embodiment of the server 114 are implemented at least in part as hardware, such functionality may be implemented with any or a combination of the following technologies, which are all well-known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

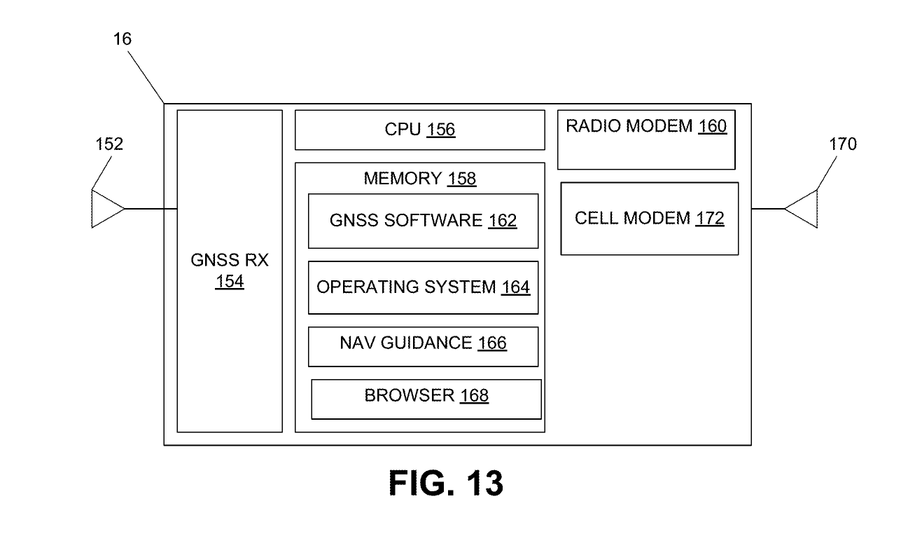

Attention is directed now to FIG. 13, which shows an embodiment of an example GNSS receiver system 16 that is incorporated in the machines 12 and/or 14. It should be appreciated by one having ordinary skill in the art in the context of the present disclosure that the architecture depicted in FIG. 13 is merely illustrative of one embodiment, and that some embodiments may include additional, fewer, and/or different components that provide for GNSS receiver and accuracy improvement functionality. In one embodiment, the GNSS receiver system 16 comprises one or more GNSS antennas 152, GNSS receiver circuitry 154, one or more processor 156 (e.g., CPU), a memory 158, and a radio modem 160. In one embodiment, the memory 158 comprises GNSS software 162, an operating system 164, navigational guidance software 166, and browser software 168. The radio modem 160 is configured to receive RTK correction information from the base station 18. The radio modem 160 may be coupled to an RF antenna 170 (e.g., high gain or directional antenna). The GNSS receiver circuitry 154 is configured to receive and track satellite signals from plural satellites 27 (FIG. 1) via the GNSS antenna 152. As is known, for coarse-level resolution, the GNSS receiver circuitry 154, in cooperation with the processor 156 and GNSS software 162 in memory 158, processes the GNSS information (e.g., C/A and P code and carrier information) received from the GNSS antenna 152 and compares the same to internally generated (e.g., by the processor 156 or by a random or pseudo random number generator) pseudorandom codes. The processor 156 measures a time-shift required to align the internally generated and received codes to compute an unambiguous pseudo-range to the satellite(s) 27.

For finer resolution, the GNSS receiver system 16 communicates with the server 114 via browser software 168 to select one or more subscriptions that provide for RTK correction. For centimeter-level accuracy, the carrier signal (e.g., the dominant spectral component remaining in the radio signal after the spectral content caused by the modulated pseudorandom digital codes (C/A and P) is removed) is tracked by the GNSS receiver circuitry 154, enabling measurements of the carrier phase to a small fraction of a complete wavelength, permitting centimeter-level (e.g., 2 centimeter) accuracy. In the case of the GNSS receiver system 16 disposed in the machine 14, for instance, the observed carrier phase information received via the GNSS receiver circuitry 154 is corrected for by the processor 156 according to the RTK correction information received from the base station 18 (FIG. 1) via the radio modem 160. The processor 156 in cooperation with the GNSS software 162 determines the position coordinates of the machine 14 according to the RTK correction information received via the RF antenna 170 and radio modem 160 and the satellite signals received via the GNSS antenna 152 and GNSS receiver circuitry 154. Note that in some embodiments, the GNSS receiver system 16 may comprise a cellular modem 172, to communicate with the server 114. Those shown as a separate piece of hardware in FIG. 13 (e.g., separate from the radio modem 160), in some embodiments, the functionality of the radio modem 160 and cellular modem 172 may be embodied in the same piece or package of hardware, with cellular modem functionality enabled via a data card. In some embodiments, the GNSS receiver system 16 of one machine may comprise a different architecture than the GNSS receiver system 16 of another machine. The position information determined by the GNSS receiver system 16 may be used as input to the navigational guidance software 166 to cause autonomous (or semi-autonomous) guided movement of the host machine (e.g., the machine 14). For instance, the position information may be used by the navigational guidance software 166 to correct a heading of the host machine 14 traversing a field according to a given wayline after driving over (or avoiding) an obstacle that alters the guided path.

In one embodiment, the memory 158 may include any one or a combination of volatile memory elements (e.g., random-access memory RAM, such as DRAM, and SRAM, etc.) and nonvolatile memory elements (e.g., ROM, hard drive, tape, CDROM, etc.). It should be appreciated that in some embodiments, additional or fewer software modules (e.g., combined functionality) may be employed in the memory 158 or additional memory. In some embodiments, a separate storage device may be coupled (e.g., via a data bus), such as a persistent memory (e.g., optical, magnetic, and/or semiconductor memory and associated drives). In some embodiments, functionality of the various circuitry may be combined into a single unit or package of circuitry.

Execution of the GNSS software 162, browser software 168, and navigational guidance software 166 and/or other software such as machine operational control software may be implemented by the processor 156 under the management and/or control of the operating system 164. The processor 156 may be embodied as a custom-made or commercially available processor, a central processing unit (CPU) or an auxiliary processor among several processors, a semiconductor based microprocessor (in the form of a microchip), a macroprocessor, one or more application specific integrated circuits (ASICs), a plurality of suitably configured digital logic gates, and/or other well-known electrical configurations comprising discrete elements both individually and in various combinations.

When certain embodiments of the GNSS receiver system 16 are implemented at least in part as software (including firmware), it should be noted that the GNSS software 162, browser software 168, and navigational guidance software 166 can be stored on a variety of non-transitory computer-readable medium for use by, or in connection with, a variety of computer-related systems or methods. In the context of this document, a computer-readable medium may comprise an electronic, magnetic, optical, or other physical device or apparatus that may contain or store a computer program (e.g., executable code or instructions) for use by or in connection with a computer-related system or method. The software may be embedded in a variety of computer-readable mediums for use by, or in connection with, an instruction execution system, apparatus, or device, such as a computer-based system, processor-containing system, or other system that can fetch the instructions from the instruction execution system, apparatus, or device and execute the instructions.

When certain embodiments of the GNSS receiver system 16 are implemented at least in part as hardware, such functionality may be implemented with any or a combination of the following technologies, which are all well-known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

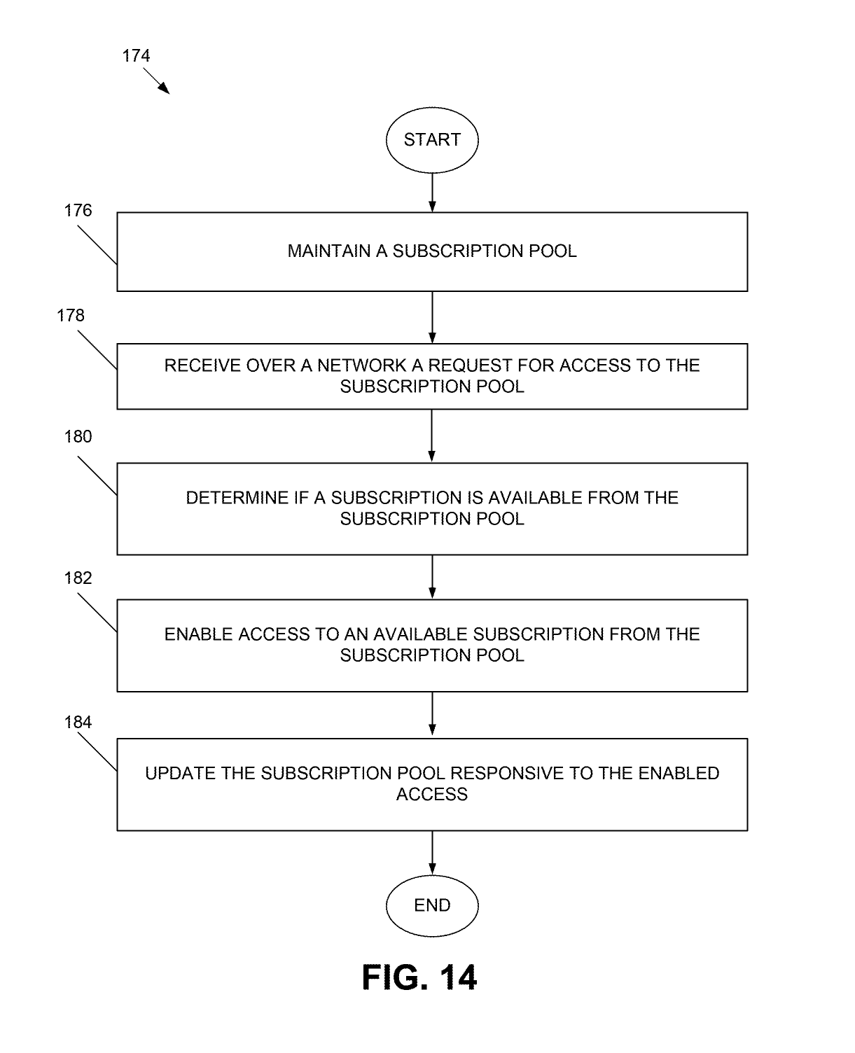

In view of the above description, it should be appreciated that one embodiment of a GNSS accuracy improvement method 174, depicted in FIG. 14 and illustrated from the perspective of a server, comprises maintaining a subscription pool (176). For instance, the subscription pool may comprise a first plurality of subscriptions for mutually exclusive access by a second plurality of remotely-located global navigation satellite systems (GNSS) receiver systems, each subscription enabling an improvement in a base accuracy of a respective GNSS receiver among the second plurality of GNSS receiver systems, wherein the first plurality is less than the second plurality. The method 174 further comprises receiving over a network a request for access to the subscription pool (178); determining if a subscription is available from the subscription pool (180); enabling access to an available subscription from the subscription pool (182); and updating the subscription pool responsive to the enabled access (184).

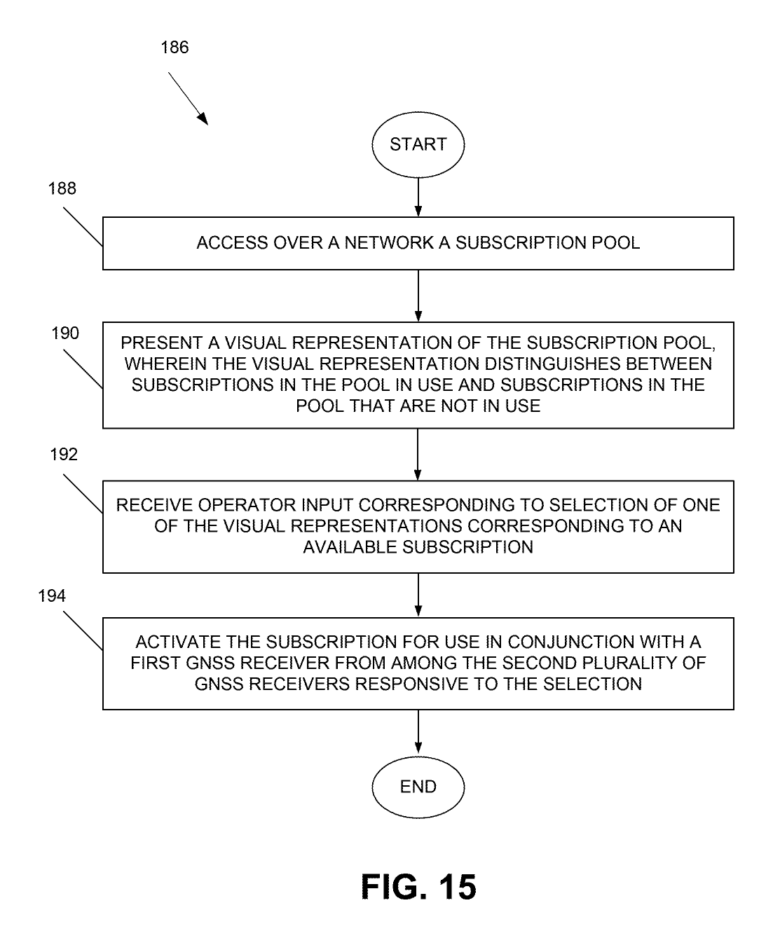

In view of the above description, it should be appreciated that one embodiment of a GNSS accuracy improvement method 186, depicted in FIG. 15 and illustrated from the perspective of a GNSS receiver system, comprises accessing over a network a subscription pool (188). For instance, the subscription pool may comprise a first plurality of subscriptions for mutually exclusive access by a second plurality of global navigation satellite systems (GNSS) receiver systems, each subscription enabling an improvement in a base accuracy of a respective GNSS receiver among the second plurality of GNSS receiver systems, wherein the first plurality is less than the second plurality. The method 186 further comprises presenting a visual representation of the subscription pool, wherein the visual representation distinguishes between subscriptions in the pool in use and subscriptions in the pool that are not in use (190); receiving operator input corresponding to selection of one of the visual representations corresponding to an available subscription (192); and activating the subscription for use in conjunction with a first GNSS receiver from among the second plurality of GNSS receivers responsive to the selection (194).

Any process descriptions or blocks in flow diagrams should be understood as representing modules, segments, or portions of code which include one or more executable instructions for implementing specific logical functions or steps in the process, and alternate implementations are included within the scope of the embodiments in which functions may be executed out of order from that shown or discussed, including substantially concurrently or in reverse order, depending on the functionality involved, as would be understood by those reasonably skilled in the art of the present disclosure.

It should be emphasized that the above-described embodiments of the present disclosure, particularly, any “preferred” embodiments, are merely possible examples of implementations, merely set forth for a clear understanding of the principles of the disclosure. Many variations and modifications may be made to the above-described embodiment(s) of the disclosure without departing substantially from the spirit and principles of the disclosure. All such modifications and variations are intended to be included herein within the scope of this disclosure and protected by the following claims.

At least the following is claimed:

1. A method, comprising:
maintaining a subscription pool, the subscription pool comprising a first plurality of subscriptions for mutually exclusive access by a second plurality of remotely-located global navigation satellite systems (GNSS) receiver systems, each subscription enabling an improvement in a base accuracy of a respective GNSS receiver among the second plurality of GNSS receiver systems, wherein the first plurality is less than the second plurality;
receiving over a network a request for access to the subscription pool;
determining if a subscription is available from the subscription pool;
enabling access to an available subscription from the subscription pool; and
updating the subscription pool responsive to the enabled access.

2. The method of claim 1, further comprising receiving a second request for access to the updated subscription pool.

3. The method of claim 2, further comprising determining if a subscription is available from the updated subscription pool.

4. The method of claim 3, further comprising denying access to the updated subscription pool responsive to a determination that all subscriptions of the updated subscription pool are in use.

5. The method of claim 1, wherein updating comprises decrementing a count corresponding to the quantity of available subscriptions of the subscription pool.

6. The method of claim 1, wherein enabling access comprises providing a visual representation of the subscription pool, the visual representation comprising selectable symbols corresponding to available subscriptions, the visual representation further comprising symbols corresponding to unavailable subscriptions.

7. The method of claim 6, wherein enabling access further comprises changing a status of a selected icon symbol available to unavailable.

8. The method of claim 7, wherein the symbols corresponding to the available subscriptions are visually discernible from the symbols corresponding to the unavailable subscriptions.

9. The method of claim 1, wherein the pool of subscriptions corresponds to a Real Time Kinematic (RTK) correction service.

10. The method of claim 1, wherein the network comprises a wide area network (WAN).

11. A method, comprising:
accessing over a network a subscription pool, the subscription pool comprising a first plurality of subscriptions for mutually exclusive access by a second plurality of global navigation satellite systems (GNSS) receiver systems, each subscription enabling an improvement in a base accuracy of a respective GNSS receiver among the second plurality of GNSS receiver systems, wherein the first plurality is less than the second plurality;
presenting a visual representation of the subscription pool, wherein the visual representation distinguishes between subscriptions in the pool in use and subscriptions in the pool that are not in use;
receiving operator input corresponding to selection of one of the visual representations corresponding to an available subscription; and
activating the subscription for use in conjunction with a first GNSS receiver from among the second plurality of GNSS receivers responsive to the selection.

12. The method of claim 11, wherein receiving the operator input corresponds to causing a change in status of the selected subscription from available to unavailable.

13. The method of claim 11, further comprising presenting a second visual representation of the subscription pool after the selection, wherein the second visual representation shows fewer subscriptions available than what is shown in the first visual representation.

14. The method of claim 11, further comprising receiving operator input corresponding to a second GNSS receiver system, wherein the operator input comprises selection of a machine hosting the second GNSS receiver system for which one of the subscriptions is desired.

15. The method of claim 14, further comprising receiving a notice of denial of access to the pool of subscriptions based on all of the subscriptions of the pool of subscriptions in use.

16. The method of claim 14, wherein the operator input corresponding to the second GNSS receiver system is received at a same machine from which the operator input corresponding to the first GNSS receiver system is received.

17. The method of claim 14, wherein the operator input corresponding to the second GNSS receiver system is received at a different machine from which the operator input corresponding to the first GNSS receiver system is received.

18. A system, comprising:
a first computing device comprising:
a storage device storing a subscription pool, the subscription pool comprising a first plurality of subscriptions for mutually exclusive access by a second plurality of remotely-located global navigation satellite systems (GNSS) receiver systems, each subscription enabling an improvement in a base accuracy of a respective GNSS receiver among the second plurality of GNSS receiver systems, wherein the first plurality is less than the second plurality;
a network interface configured to receive over a network a request for access to the subscription pool; and
a processor configured to:
determine if a subscription is available from the subscription pool;
enable access to an available subscription from the subscription pool; and
update the subscription pool responsive to the enabled access.

19. The system of claim 18, further comprising a second computing device configured to provide correction information to one of the second plurality of GNSS receiver systems according to one of the subscriptions.

20. The system of claim 19, further comprising a vehicle, wherein the vehicle comprises:
one of the GNSS receiver systems, wherein the one of the GNSS receiver systems comprises;
a GNSS receiver;
a radio frequency modem comprising a data card;
a network interface; and
a processor configured to:
send requests via the network interface and the radio frequency modem to the first computing device for access to the subscription pool;
select an available subscription from a displayed subscription pool; and
receive the correction information from the radio frequency modem and the network interface based on the selection and enabled access by the first computing device, the correction information received by the radio frequency modem or the GNSS receiver and the satellite signals received by the GNSS receiver enabling a determination by the processor of a geographical position of the vehicle.
